(19) United States
(12) Patent Application Publication
(10) Pub. No.: US 2005/0169241 A1
(43) Pub. Date: Aug. 4, 2005

(54) Integrated voice and data switching system

(76) Inventor: Young-Hoon Ko, Seoul (KR)

Correspondence Address: Robert E. Bushnell;Suite 300, 1522 K Street, N.W., Washington, DC, 20005-1202, US

(21) Appl. No.: 11/010,286

(22) Filed: Dec. 14, 2004

(30) Foreign Application Priority Data
Jan. 30, 2004 (KR) 2004-6310

(51) Int. Cl. H04L 12/28

(52) U.S. Cl. 370/351

(57) ABSTRACT

A voice and data switching system integrates a router/data switching module into a voice PBX to form an integrated voice and data switch to provide an IP-based voice and data service platform, which can be easily installed and unified in operation and maintenance and serve as a platform for IP-based voice and data services. The integrated switching system is linked to at least one network and includes an integrated voice and data processing module. The processing module respectively converts the format of an voice signal input via a first network and voice data packets input from second and third networks into voice data packets and a voice signal and respectively transmits the voice data packets and the voice signal to the second and first networks; switches the voice data packets to the second network and the voice signal to the first network; and routes the switched voice packets via a corresponding network in accordance with a set routing information.

### CLAIM OF PRIORITY

This application makes reference to, incorporates the same herein, and claims all benefits accruing under 35 U.S.C. §119 from an application for VOICE AND DATA INTEGRATED SWITCHING SYSTEM earlier filed in the Korean Intellectual Property Office on 30 Jan., 2004 and there duly assigned Serial No. 2004-6310.

### BACKGROUND OF THE INVENTION

1. Field of the Invention

The present invention relates to an integrated voice and data switching system, more particularly, the present invention relates to an integrated voice and data switching system which has a switch module included in a Private Branch Exchange (PBX) to enable both voice and data services in the PBX.

2. Description of the Related Art

Nowadays, the Internet Protocol (IP) network is improving performance and service through the rapid spread of the Internet and the demand for various services associated therewith. As a result, more services are required in the market.

As one of the requirements, voice transmission via the IP network is one major function of the IP network as is data transmission, which also requires various voice transmission techniques associated therewith. Therefore, there is a need for the integration between conventional terminal communication using digital telephones, analog telephones and so on and Voice over IP (VoIP) communication.

Accordingly, terminals available on the IP network are necessarily designed to have the same shape and operation as those of conventional digital telephones so as to meet various requirements. Internet-phones (IP-phones) are being developed as a result of such requirements.

In general, the IP-phones communicate with a switching system via the ITU-T recommended H.323 protocol. The H.323 protocol is for multimedia communications such as voice, image and data.

The following patents each discloses features in common with the present invention but do not teach or suggest the inventive features specifically recited in the present claims:

### SUMMARY OF THE INVENTION

It is an object of the present invention to provide an integrated voice and data switching system having a router, a data switch and a voice PBX integrated combined into one unit to facilitate installation and to enable unified operation and maintenance, by which conventional voice terminals and PSTN interface modules can be used, and conventional voice calling together with voice calling and various multimedia data services via the Internet can be realized with a single piece of equipment.

According to an aspect of the present invention for realizing the above objects, a system is provided comprising: an integrated voice and data processing module including: a converter adapted to respectively convert a format of a voice signal inputted via a first network and voice data packets inputted via second and third networks into converted voice data packets and a converted voice signal; a transmitter adapted to respectively transmit the converted voice data packets and the converted voice signal to the second and first networks; a switch adapted to switch the converted voice data packets to the second network and the converted voice signal to the first network; and a router adapted to rout the switched voice packets via a corresponding network in accordance with set routing information.

Preferably, the first network comprises a Public Service Telephone Network (PSTN), and wherein the input voice signal received via the first network is a Pulse Code Modulation (PCM) coded voice signal.

Preferably, the second network comprises an Internet Protocol (IP) network linked via at least one interface selected from the group consisting of a Local Area Network (LAN), a Wide Area Network (WAN), an xDigital Subscriber Line (xDSL) and a cable modem, and wherein the input voice data packets received via the second network are Voice over Internet (VoIP) packets.

Preferably, the integrated voice and data processing module comprises: a voice converter adapted to compress a PCM coded voice signal inputted via the first network into compressed voice data packets and to convert voice packets inputted via a network into a PCM coded voice signal before outputting it; a controller adapted to switch and rout the compressed voice data packets from the voice converter in accordance with set routing information and to output converted voice data packets inputted via the second network into the voice converter; and a switch adapted to switch the input voice data packet inputted via the second network to the controller and to switch the routed voice data packet from the controller to a corresponding network interface.

The system preferably further comprises at least one interface adapted to interface the routed voice data packet from the controller via a WAN serial port, an xDSL modem, a cable modem and a DMZ port to the IP network, and to interface the routed voice data packets to the switch.

The system preferably further comprises at least one Ethernet interface adapted to interface the switched voice data packets from the switch to a corresponding terminal in accordance with corresponding IP address information, and to interface input voice data packets from the terminal via the switch to the controller.

The system preferably further comprises an uplink interface adapted to interface the switched voice data packets from the switch to an upper link, and to interface voice data packets received via the upper link to the switch.

The system preferably further comprises: a dual port memory adapted to temporarily store signaling messages processed by the controller for both caller and called IP call processing; and a memory adapted to store routing information, subscriber information and programs for execution by the controller.

The system preferably further comprises a security processor connected via a PCI bus to the controller and adapted to execute a hardware-based tunneling function via data encryption, decryption and authentication for establishment of an imaginary private LAN.

According to another aspect of the present invention for realizing the above objects, a system is provided comprising: a voice converter adapted to compress a Pulse Code Modulation (PCM) coded voice signal inputted via a first network into compressed voice data packets and to convert voice packets inputted via a network into a converted PCM coded voice signal and to output it to a first network; a controller adapted to switch and rout the compressed voice data packet from the voice converter in accordance with set routing information and to output input voice data packets inputted via a second network into the voice converter; and a switch adapted to switch the input voice data packets inputted via the second network to the controller and to switch the routed voice data packets from the controller to a corresponding network interface; wherein the voice converter, the controller and the switch are integrated into a single module.

The system preferably further comprises at least one interface adapted to interface the routed voice data packets from the controller via at least one of a WAN serial port, an xDSL modem, a cable modem and a DMZ port to the IP network, and to interface the routed voice data packets to the switch.

The system preferably further comprises at least one Ethernet interface adapted to interface the switched voice data packets from the switch to a corresponding terminal in accordance with corresponding IP address information, and to interface input voice data packets from the terminal via the switch to the controller.

The system preferably further comprises an uplink interface adapted to interface the switched voice data packets from the switch to an upper link, and to interface voice data packets received via the upper link to the switch.

The system preferably further comprises a dual port memory adapted to temporarily store signaling messages processed by the controller for both caller and called IP call processing; and a memory adapted to store routing information, subscriber information and programs for execution by the controller.

The system preferably further comprises a security processor connected via a PCI bus to the controller and adapted to execute a hardware-based tunneling function via data encryption, decryption and authentication to establish an imaginary private LAN.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a voice PBX connected to an ethernet switch;

FIG. 2 is a block diagram of an integrated voice and data switching system in accordance with an embodiment of the present invention; and

FIG. 3 is an internal block diagram of the voice and data integrated switching system in FIG. 2.

### DETAILED DESCRIPTION OF THE INVENTION

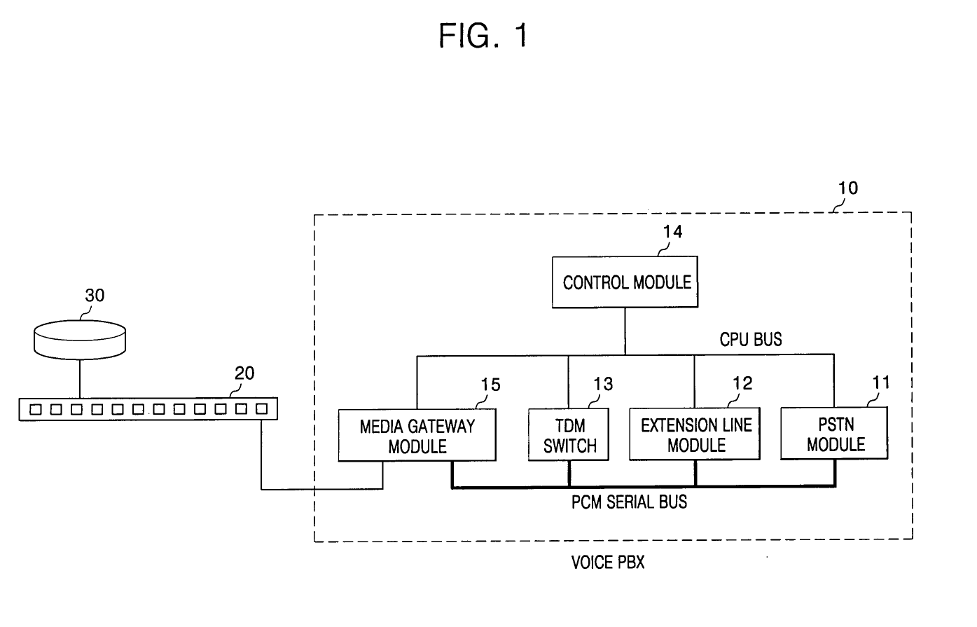

FIG. 1 is a block diagram of a voice PBX connected to an ethernet switch in an IP based voice communication system.

As shown in FIG. 1, an IP based voice communication system includes a voice PBX 10, a data switch 20 and a router 30.

The voice PBX 10 converts voice data into packet data, and the switch 20 switches the packet data to the router 30. An ethernet switch is one example of the data switch 20.

The router 30 transmits the voice packet data switched by the data switch 20 to the Internet.

The voice PBX 10 includes a Public Switched Telephone Network (PSTN) module 11 for interfacing with a PSTN, an extension line module 12 for interfacing with extension subscriber terminals, a Time Division Multiplexing (TDM) switch module 13 for dividing a plurality of voice signals according to respective time periods (e.g., time slots), a media gateway module 15 for converting the voice signals transmitted from the TDM switch module 13 into voice data packets and converting voice data packets transmitted from the data switch 20 into PCM-coded voice signals or PCM voice signals and a control module 14 for controlling these modules. The media gateway module 15, the TDM switch module 13, the extension line module 12 and the PSTN module 11 are connected to one another via a PCM serial bus and the control module 14 is connected to the modules 11, 12, 13 and 15 via a CPU bus. The media gateway module 15 in the voice PBX 10 compresses PCM-converted voice signals into voice packets and transmits the voice packets to the data switch 20, and restores voice packets from the data switch 20 into PCM voice signals.

As shown in FIG. 1, the voice PBX 10, the external data switch 20, and the additional media gateway module 15 are needed to allow the former to cooperate with each other and the router 30 is needed to allow the link to the PSTN to execute IP based voice communication services. As a consequence, the data switch 20, the router 30 and the voice PBX 10 are provided as separate equipment and are disadvantageous with regard to system operation and maintenance.

An embodiment of a call processing system and method in an integrated voice and data switching system in accordance with an embodiment of the present invention is described below in detail with reference to the accompanying drawings.

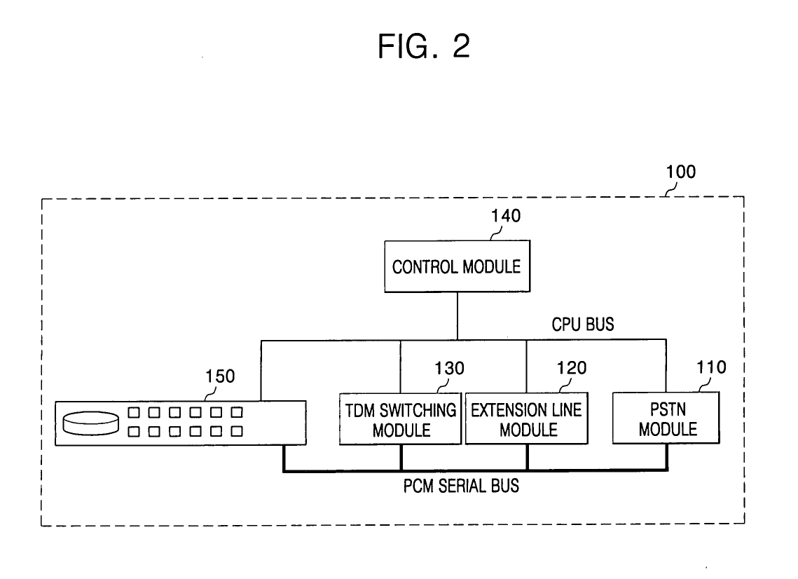

FIG. 2 is a block diagram of an integrated voice and data switching system in accordance with an embodiment of the present invention.

As shown in FIG. 2, the voice and data integrated switching system 100 includes a PSTN module 110, an extension line module 120 and a TDM switching module 130, a control module 140 and a voice and data processing module 150. In FIG. 2, the elements that are the same as those of FIG. 1 will not be further described.

The voice and data integrated switching system 100 provided in the voice and data processing module 150 is realized by integrating a router, a data switching module and a media gateway module in a voice PBX into one module, which are separate modules in FIG. 1.

That is, unlike the system of FIG. 1, in which the data switch and router are provided outside the voice PBX, as shown in FIG. 2, the present invention includes the router and the data switch within the voice PBX, so that a single module can execute a voice compression codec function which has previously been performed in a media gateway module.

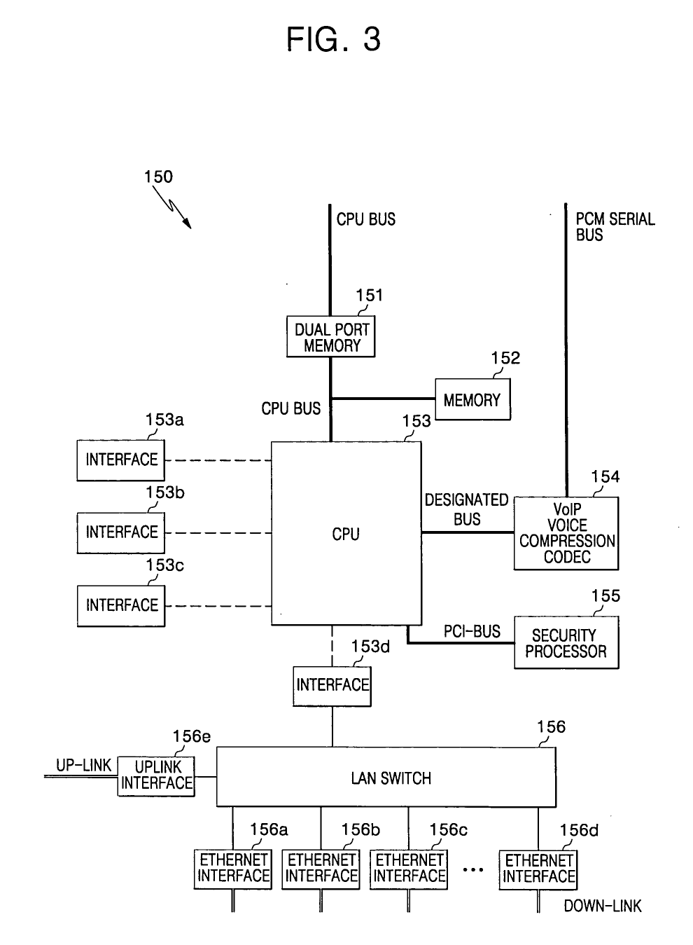

The operation of the voice and data processing module 150 including the router, the data switch and the media gateway modules integrated into one unit is described below in detail with reference to FIG. 3.

FIG. 3 is a block diagram of a voice and data processing module of the voice and data integrated switching system in FIG. 2.

As shown in FIG. 3, the voice and data processing module 150 includes a dual port memory 151, a memory 152, a CPU 153, a Voice over Internet Protocol (VoIP) voice compression codec 154, a security processor 155 and an LAN switch 156.

The dual port memory 151 stores signaling messages inputted via a first port from the control module 140 of FIG. 2 so that the CPU 153 can read the stored signaling messages from the dual port memory 151 via a second port.

The memory 152 includes a RAM and a flash memory, and stores various data including programs necessary for the operation of the CPU 153, routing information (for example, a routing table) and subscriber information.

By using routing information (IP information, port information, etc.) stored in the memory 152, the CPU 153 transmits voice data packets via interfaces 153a to 153c to the Internet, and via interface 153d to the LAN switch 156 so that the voice data packets can be sent to an IP network.

Upon receiving the voice data packets via interfaces 153a to 153d, the CPU 153 forwards the voice data packets to the VoIP voice compression codec 154. As a result, the CPU 153 controls the routing and switching of the voice data packets.

The CPU 153 is connected to interfaces 153a to 153d. The interface 153a includes a V.35 transceiver to transmit/receive data packets via a WAN serial port, and the interfaces 153b and 153c transmit/receive data packets via an xDSL or cable modem.

The interface 153d is an interface for providing a data packet channel to the LAN switch 156, and, although not shown in the drawings, may include a DMZ interface for linking to a web page server or an e-mail server.

The VoIP voice compression codec 154 converts a PCM-coded voice signal from the TDM switching module in FIG. 2 into IP voice data packets, and compresses the IP voice data packets to be transmitted via the CPU 153 to the IP network. The VoIP voice compression codec 154 also converts voice data packets received via the IP network into a PCM voice signal, and provides the PCM voice signal via a PCM serial bus to the TDM switching module 130 of FIG. 2.

The security processor 155 is connected to the CPU 153 via a PCI bus to realize a hardware based tunneling function via data encryption, decryption and authentication needed for the establishment of a Virtual Private LAN (VPN). That is, the voice and data packets to be transmitted/received are encrypted or decrypted via encapsulation/decapsulation to thereby establish the VPN.

The LAN switch 156 receives voice data packets from the CPU 153 via the interface 153d, and transmits the voice data packets to a called or destination terminal via any of the interfaces 156a to 156d corresponding to the destination terminal. An ethernet interface is an example of the interfaces 156a to 156d, and a PC, an IP phone and so on are examples of the terminals connected to the interfaces 156a to 156d.

Furthermore, the LAN switch 156 receives voice and data packets from terminals via the interfaces 156a to 156d, and provides the voice and data packets to the CPU 153 via the interface 153d. The CPU 153 provides the received voice and data packets to the VoIP voice compression codec 154.

The LAN switch 156 is connected to an uplink interface 156e which can transmit/receive voice and data packets via uplink (e.g., at a ratio of 100 M/1 G).

The operation of the integrated voice and data switching system noted above is described in detail as follows.

First, a signaling message regarding an input IP voice call is provided via the LAN switch 156 to the CPU 153, which in turn converts the signaling message regarding an input IP call into a voice call processing message and provides the converted voice call processing message via the dual port memory 151 to the control module 150 shown in FIG. 2.

A signaling message for outgoing IP voice call processing is provided to the CPU 153 via the dual port memory 151 in the voice and data processing module 150 of FIG. 3 from the control module 140 of FIG. 2, in which the CPU 153 converts the signaling message for the processing of an outgoing IP voice call into IP message packets and transmits the IP message packets via the LAN switch 156 to a terminal connected to the IP network.

IP voice packets introduced via the interfaces 156a to 156d are forwarded via the LAN switch 156 to the CPU 153, and IP voice data packets forwarded to the interfaces 153a to 153d via the VAN, xDSL or cable modem are forwarded to the CPU 153.

The CPU 153 forwards the IP voice data packets via a designated bus to the VoIP voice compression codec 154.

The VoIP voice compression codec 154 converts the IP voice data packets from the CPU 153 into a PCM coded voice signal, and forwards the PCM coded voice signal via the PCM serial bus to the TDM switching module 130 as shown in FIG. 2.

On the other hand, a PCM coded voice signal transmitted via the PCM serial bus from the TDM switching module 130 of FIG. 2, is converted into IP voice packets by the VoIP voice compression codec 154, which in turn forwards the IP voice packets via a designated bus to the CPU 153.

The CPU 153 forwards the IP voice packets from the VoIP voice compression codec 154 to the LAN switch 156, which in turn forwards the IP voice packets from the CPU 153 via the interfaces 153a to 153d to the IP network and then to the address of a corresponding terminal.

IP packets inputted to the interfaces 153a to 153c of FIG. 3, such as a WAN serial port, xDSL modem and cable modem, are forwarded via the interfaces 153a to 153c to the CPU 153.

The CPU 153 then analyzes the header of the IP packets forwarded via the interfaces 153a to 153c. Based upon the header information and the routing information stored in the memory 152, the IP packets are transferred to the destination IP address via the interfaces 153a to 153c, that is, a WAN serial port, an sDSL modem or a cable modem or to a corresponding terminal via the LAN switch 156. The routing operation executed by the CPU 153 will not be described further in detail since it is substantially the same as that of a typical routing operation.

Furthermore, the security processor 156 connected to the CPU 153 via the PCI bus effects a hardware based tunneling function via data encryption, decryption and authentication needed for the constitution of an imaginary private LAN to prevent any performance degradation of the whole module.

The above embodiment of the present invention described in conjunction with FIGS. 2 and 3 is merely for illustrative purposes only, but is not to be construed as limiting the scope of the present invention. It is to be understood that those skilled in the art can realize various forms of switching systems without departing from the scope of the present invention. Since various changes and modifications according to the embodiments of the present invention can be proposed by the those skilled in the art, the scope of the present invention is defined only by the appended claims.

As set forth above, the voice and data switching system of the present invention integrates the router/data switching module into a conventional voice PBX to realize an integrated voice and data switch, thereby providing an IP-based voice and data service platform, which can be easily installed and unified in operation and maintenance and serve as a platform for IP-based voice and data services.

Furthermore, the voice and data switching system of the present invention can also provide legacy voice terminal or PSTN interface module links as well as allowing a user PC to be linked to various servers.

1. A system comprising:
an integrated voice and data processing module including:
a converter adapted to respectively convert a format of a voice signal inputted via a first network and voice data packets inputted via second and third networks into converted voice data packets and a converted voice signal;
a transmitter adapted to respectively transmit the converted voice data packets and the converted voice signal to the second and first networks;
a switch adapted to switch the converted voice data packets to the second network and the converted voice signal to the first network; and
a router adapted to route the switched voice packets via a corresponding network in accordance with set routing information.

2. The system according to claim 1, wherein the first network comprises a Public Service Telephone Network (PSTN), and wherein the input voice signal received via the first network is a Pulse Code Modulation (PCM) coded voice signal.

3. The system according to claim 1, wherein the second network comprises an Internet Protocol (IP) network linked via at least one interface selected from the group consisting of a Local Area Network (LAN), a Wide Area Network (WAN), an xDigital Subscriber Line (xDSL) and a cable modem, and wherein the input voice data packets received via the second network are Voice over Internet (VoIP) packets.

4. The system according to claim 1, wherein the integrated voice and data processing module comprises:
a voice converter adapted to compress a PCM coded voice signal inputted via the first network into compressed voice data packets and to convert voice packets inputted via a network into a PCM coded voice signal before outputting it;
a controller adapted to switch and rout the compressed voice data packets from the voice converter in accordance with set routing information and to output converted voice data packets inputted via the second network into the voice converter; and
a switch adapted to switch the input voice data packet inputted via the second network to the controller and to switch the routed voice data packet from the controller to a corresponding network interface.

5. The system according to claim 4, further comprising at least one interface adapted to interface the routed voice data packet from the controller via a WAN serial port, an xDSL modem, a cable modem and a DMZ port to the IP network, and to interface the routed voice data packets to the switch.

6. The system according to claim 4, further comprising at least one Ethernet interface adapted to interface the switched voice data packets from the switch to a corresponding terminal in accordance with corresponding IP address information, and to interface input voice data packets from the terminal via the switch to the controller.

7. The system according to claim 4, further comprising an uplink interface adapted to interface the switched voice data packets from the switch to an upper link, and to interface voice data packets received via the upper link to the switch.

8. The system according to claim 4, further comprising:
a dual port memory adapted to temporarily store signaling messages processed by the controller for both caller and called IP call processing; and
a memory adapted to store routing information, subscriber information and programs for execution by the controller.

9. The system according to claim 4, further comprising a security processor connected via a PCI bus to the controller and adapted to execute a hardware-based tunneling function via data encryption, decryption and authentication for establishment of an imaginary private LAN.

10. A system comprising:
a voice converter adapted to compress a Pulse Code Modulation (PCM) coded voice signal inputted via a first network into compressed voice data packets and to convert voice packets inputted via a network into a converted PCM coded voice signal and to output it to a first network;
a controller adapted to switch and rout the compressed voice data packet from the voice converter in accordance with set routing information and to output input voice data packets inputted via a second network into the voice converter; and
a switch adapted to switch the input voice data packets inputted via the second network to the controller and to switch the routed voice data packets from the controller to a corresponding network interface;
wherein the voice converter, the controller and the switch are integrated into a single module.

11. The system according to claim 10, further comprising at least one interface adapted to interface the routed voice data packets from the controller via at least one of a WAN serial port, an xDSL modem, a cable modem and a DMZ port to the IP network, and to interface the routed voice data packets to the switch.

12. The system according to claim 10, further comprising at least one Ethernet interface adapted to interface the switched voice data packets from the switch to a corresponding terminal in accordance with corresponding IP address information, and to interface input voice data packets from the terminal via the switch to the controller.

13. The system according to claim 10, further comprising an uplink interface adapted to interface the switched voice data packets from the switch to an upper link, and to interface voice data packets received via the upper link to the switch.

14. The system according to claim 10, further comprising:
a dual port memory adapted to temporarily store signaling messages processed by the controller for both caller and called IP call processing; and
a memory adapted to store routing information, subscriber information and programs for execution by the controller.

15. The system according to claim 10, further comprising a security processor connected via a PCI bus to the controller and adapted to execute a hardware-based tunneling function via data encryption, decryption and authentication to establish an imaginary private LAN.
